(19) United States
(12) Patent Application Publication
(10) Pub. No.: US 2006/0253321 A1
(43) Pub. Date: Nov. 9, 2006

(54) Loyalty enrollment systems and methods

(75) Inventor: Chaun P. Heywood, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/124,423

(22) Filed: May 6, 2005

(51) Int. Cl. G06Q 30/00

(52) U.S. Cl. 705/14

(57) ABSTRACT

Systems and methods are disclosed for enrolling candidate participants in loyalty programs. In one embodiment, the method comprises obtaining an enrollment rule for a loyalty program, the enrollment rule including one or more conditions for the loyalty program, obtaining at least one attribute for a candidate participant and evaluating the enrollment conditions using the at least one attribute. If the enrollment conditions are satisfied, the candidate participant is automatically enrolled in the loyalty program.

COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyright rights whatsoever.

### BACKGROUND OF THE INVENTION

Loyalty programs usually offer an incentive designed to encourage customers to conduct business with one organization rather than a competitor organization. One type of loyalty program takes the form of a point system in which a customer is credited with a number of points for each transaction and is entitled to exchange a certain number of points for goods, services, or other rewards. The reward type is typically chosen by the issuer of the loyalty program. Alternatively, a customer may be able to choose the type of reward during enrollment in the loyalty program. Another type of loyalty program offers customers associated with the loyalty program a discount on items, which may be designated by the merchant.

An example of the first type of loyalty program is a frequent flyer program offered by an airline. An airline typically offers some number of points to each customer that is correlated with the distance traveled. At certain levels, the points may be exchanged by the customer for airline tickets. In some cases, additional incentives may be used to induce customers to reach certain point levels, such as by providing preferential seating and booking privileges. Similar loyalty programs are used in environments for the sale of goods or services, with customers of a particular organization being entitled to rewards in exchange for certain levels of business.

Examples of the second type of loyalty program, in which a customer participating in a loyalty program is offered a discount, include loyalty programs offered by grocery organizations. A grocery store organization may offer a discount on designated items to customers having a loyalty program account. In some cases, the loyalty program may also offer the customers other rewards or benefits when the customer reaches certain levels of business with the grocery store organization.

Loyalty program issuers and members alike may both be dissatisfied with the limited choices available with today's loyalty programs. Issuers may be dissatisfied with the limited options available in setting up a loyalty program. For instances, the type of reward criteria that may be specified by an issuer is restricted to very basic criteria that is statically applied to all of the members of the loyalty program. On the other hand, members may be dissatisfied with the restrictions on rewards. Often a loyalty program member does not have the ability to choose the type of reward he or she will receive. Even if a choice is provided, the loyalty program member is limited to one type of program chosen during enrollment. Other limitations for both issuers and members also exist. Thus, a more flexible loyalty system is needed.

### BRIEF SUMMARY OF THE INVENTION

Systems, methods, and machine-readable mediums are disclosed for enrolling candidate participants in loyalty programs. In some embodiments, the method comprises obtaining, with a loyalty system, an enrollment rule for a loyalty program. The enrollment rule includes one or more enrollment conditions for the loyalty program. At least one attribute associated with a candidate participant is also obtained with the loyalty system. The candidate participant may be a participant in another loyalty program administered by the loyalty system or any other individual about whom the loyalty system has or can obtain information. The enrollment condition(s) are evaluated using the at least one attribute. If the enrollment conditions are satisfied, the candidate participant is automatically enrolled in the loyalty program.

In some aspects, the enrollment condition(s) may comprise an associated account condition. The attribute(s) associated with the candidate participant may comprise any of a variety of different types of attributes associated with a participant account (e.g., credit card account, checking account, savings account, loan account, etc.). Merely by way of example, the attribute may comprise an account balance, an available balance, an account status, a total purchase amount for a designated time period, and/or the existence of the associated account.

In other aspects, the enrollment condition(s) may comprise a transaction history condition. Attribute(s) used to evaluate the transaction history condition may comprise a total purchase amount for a designated time period, a purchase of a designated item, a purchase from a designated merchant, and/or any other type of transaction history attribute associated with the candidate participant.

The method may also comprise obtaining, with the loyalty system, a second enrollment rule for a second loyalty program. The second enrollment rule includes one or more enrollment conditions for the second loyalty program. A determination may be made as to whether the candidate participant satisfies the enrollment conditions for the second loyalty programs. In some embodiments, if the candidate participant satisfies the enrollment conditions for the second loyalty program, an offer may be transmitted to the candidate participant to enroll in the second loyalty program. For instances, transmitting the offer may comprise transmitting an offer message to a merchant device from which transaction purchase information associated with the candidate participant was received. Other means may also be used to transmit the enrollment offer.

In still further embodiments, the method may comprise obtaining, with the loyalty system, a removal rule for the loyalty program. The removal rule includes one or more removal conditions for the loyalty program. By way of example, the removal condition may comprise failure to meet a purchase threshold for a predetermined time period. A determination is made as to whether a participant in the loyalty program satisfies the removal condition(s). If the participant satisfies the removal condition(s), the participant is automatically removed from the loyalty program.

In other embodiments, a loyalty system is disclosed which comprises a rules data store and logic, communicatively coupled with the rules data store. The rules data store includes an enrollment rule for a loyalty program which has one or more enrollment condition(s) for the loyalty program. The logic is configured to obtain the enrollment rule from the rules data store and to obtain at least one attribute for a candidate participant. The logic is also configured too evaluate the enrollment condition(s) using the at least one attribute. If the enrollment condition(s) are satisfied, the logic is configured to automatically enroll the candidate participant in the loyalty program.

The loyalty system may also comprise a data store to store participant attributes for a plurality of participants in one or more loyalty programs administered by the loyalty system. The logic may be configured to obtain the at least one attribute from the attribute data store. In some embodiments, the participant attributes may include at least one associated account attribute for an associated account.

In other aspects, the rules data store may further include a removal rule having one or more removal conditions for the loyalty program. The logic may be further configured to obtain the removal rule and to determine if a participant in the loyalty program satisfies the removal condition(s). If the participant satisfies the removal condition(s), the participant may be automatically removed from the loyalty program. In still further aspects, the loyalty system may further comprise an interface to receive the enrollment rule from a loyalty provider.

A further understanding of the nature and advantages of the present invention may be realized by reference to the remaining portions of the specification and the drawings.

### BRIEF DESCRIPTION OF THE DRAWINGS

Illustrative embodiments in accordance with the invention are illustrated in the drawings in which:

FIG. 1 illustrates an exemplary embodiment of a system which may use a loyalty system to administer and operate loyalty programs;

FIG. 2 is a block diagram of an exemplary components of a loyalty system;

FIG. 3 is a block diagram of an exemplary computer system upon which a loyalty system or components of a loyalty system may be implemented;

FIG. 4 is a flow diagram illustrating exemplary creation of different types of rules that may be used to administer loyalty programs;

FIG. 5 is a flow diagram of an exemplary method that may be used to process a loyalty transaction;

FIG. 6 is a flow diagram illustrating an exemplary interaction of a customer with a user interface that may be used to redeem loyalty rewards;

FIG. 7 illustrates an exemplary display of loyalty account information that may be provided by a loyalty system

FIG. 8 illustrates a user interface display that may be used to redeem loyalty points;

FIG. 9 illustrates an exemplary display that may be provided by a loyalty system to redeem loyalty points for a money transfer;

FIG. 10 illustrates an exemplary display that may be provided by a loyalty system to redeem loyalty points for a charitable donation; and

FIG. 11 illustrates an exemplary display that may be provided to display detailed loyalty program information.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

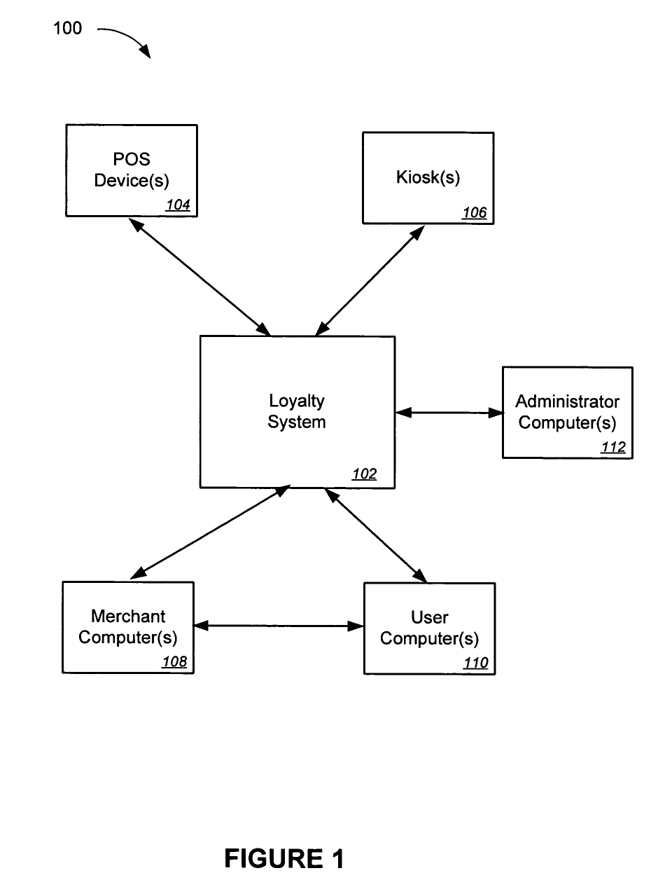

FIG. 1 illustrates an exemplary embodiment of a system 100 that may use a loyalty system 102 to administer loyalty programs. In one embodiment, the loyalty system 102 may operate for a plurality of merchants related by a merchant association. Merchants in the merchant association may provide a variety of different types of goods or services to customers. The merchant association may offer one or more loyalty programs to customers to provide incentives for doing business with merchants in the association. In alternative embodiments, loyalty system 102 may operate on behalf of an issuer association (e.g., a credit card association) or a plurality of issuer associations. Further details of such loyalty systems may be found in application Ser. No. 10/079,927, entitled “Systems and Methods for Operating Loyalty Programs,” filed on Feb. 19, 2002, the details of which are hereby incorporated by reference.

Customers may be able to initiate a transaction with a merchant in any of a number of different ways. For example, a customer may initiate a transaction with a merchant by walking into a retail location and purchasing goods and services. A customer may also be able to initiate a transaction with a merchant via a kiosk terminal 104. As a third example, a customer may initiate a transaction (e.g., an Internet transaction to purchase goods or services) via a user computer 108 communicatively coupled with a merchant server 106.

Details of the transaction may be transmitted by point-of-sale device 102 located at a retail location, kiosk 104, and/or merchant computer 106 to a loyalty system 102. Loyalty system 102 may administer one or more loyalty programs for merchant(s), merchant association(s), issuer association(s), and/or manufacturers. In some embodiments, loyalty system 102 may be part of a larger transaction system (not shown) that includes one or more machines that perform transaction authorization and settlement functions. In alternative embodiments, loyalty system 102 may be a standalone system.

Loyalty program administrator(s) 112 may be able to access loyalty system 102 to set up rule(s) associated with loyalty program(s). A loyalty program administrator 112 may be acting on behalf of a merchant, merchant association, issuer association, or manufacturer, or other entity providing the loyalty program(s). The rules may specify criteria used by loyalty system 102 to evaluate a transaction to determine loyalty program reward eligibility, reward type, and/or reward amount. An administrator 112 may also or alternatively specify enrollment criteria rules, redemption rules, return processing rules, or any other types of rules related to loyalty program(s).

In some aspects, an administrator 112 may be able to create rules that direct loyalty system 102 to evaluate attributes of a participant's financial account(s) or other account(s) (e.g., health care account, utility account, etc.). The account attributes may be used to determine reward eligibility, reward type, reward amount, redemption conditions, or other conditions for rules associated with loyalty program(s). Merely by way of example, attributes of a participant's credit card account (e.g., credit card balance, interest rate, credit card type, payment history, account status, etc.) may be used by loyalty system 102 to determine whether a transaction is eligible for a reward and/or the amount of reward to provide. Additional examples of rules that specify reward criteria based on associated account attributes or other criteria are described below.

In other aspects, a loyalty program provider may allow its participants to participate in multiple loyalty programs offered by the loyalty program provider. In these aspects, rule(s) may be created by an administrator 112 which specify criteria for the different loyalty program(s). The rules may then be used by loyalty system 102 to automatically enroll participants in one or more of the programs offered by the loyalty program provider, to remove participants from one or more of the programs, to upgrade or downgrade a loyalty status, and/or to process enrollment requests.

Participants may, in some embodiments, interact with loyalty system 102 to redeem rewards. In these embodiments, loyalty system 102 may provide a web site or other type of user interface that may be accessed by participants to view reward summaries and redeem rewards. As will be described in more detail below, a participant may be given an option to participate in loyalty program(s) which allows the participants to select between multiple redemption options to redeem rewards. Merely by way of example, redemption options may include gift certificates, charity donations, travel discounts, merchandise discounts, money transfers, cash rewards, college saving account contributions, or other types of rewards. Loyalty system 102 may process the reward redemptions and otherwise manage participants' reward accounts.

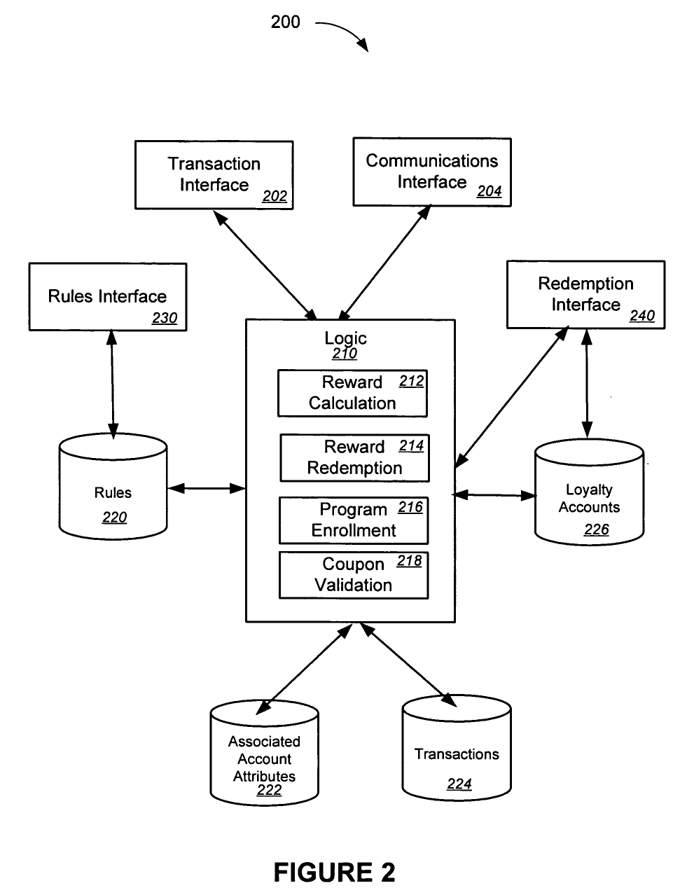

FIG. 2 illustrates an exemplary embodiment of components of a loyalty system 200. Loyalty system 200 may include logic 210 communicatively coupled with one or more interfaces 202, 204, 230, 240 to loyalty system 200. Logic 210 may also be communicatively coupled with one or more data stores 220, 222, 224, 226 used to store information used by loyalty system 200 to administer loyalty programs. A communicative coupling is a coupling that allows communication between the components. This coupling may be by means of a bus, cable, network, wireless mechanism, program code call (e.g., modular or procedural call) or other mechanism that allows communication between the components. Thus, it should be appreciated that logic 210 or components of logic 210, interfaces 202, 204, 230, 240 and data stores 220, 222, 224, 226 may reside on the same or different physical devices.

Interfaces that may be provided by loyalty system 200 may include transaction interface(s) 202, rules interface 230, redemption interface 240, and/or additional communication interface(s) 204. Merely by way of example, interfaces 202, 204, 230, 240 may comprise an interface to a public network (e.g., the Internet) and/or an interface to a proprietary network. In some aspects, transaction interface(s) 202, rules interface 230, redemption interface 240, and/or other communication interface(s) 204 may share the same physical interface to a machine.

Transaction interface(s) 202 may be used to receive transaction information for the purchase of goods or services. Transaction information may include a dollar amount of the transaction, product level transaction detail (e.g., SKU, product prices, etc.), a loyalty account identifier, merchant identifier, and/or any other information used by loyalty system 102 to determine whether the transaction qualifies for loyalty program rewards and/or reward amount(s). In some embodiments, transaction details may be transmitted to loyalty system 200 in real-time from point-of-sale devices, kiosks, and/or merchant servers. Alternatively or additionally, transaction details for individual or multiple transactions may be transmitted at a later time to the loyalty system 200 for loyalty processing.

Rules interface 230 may be an interface provided by loyalty system 200 to allow loyalty program administrators to set up or edit rules for loyalty program(s). By way of example, rules interface 230 may be a web-based interface or other type of graphical user interface. Rules interface 230 may be communicatively coupled with a rules data store 220 used to store loyalty program rules.

Redemption interface 240 may be an interface provided by loyalty system 200 to allow participants in loyalty program(s) to view details about their loyalty program accounts. Participants may also be able to interact with redemption interface 240 to redeem loyalty rewards. Loyalty information for participants may be retrieved from loyalty account data store 226, which is communicatively coupled with redemption interface 240. In some embodiments, redemption interface 240 may be a graphical user interface, such as a web-based interface. Exemplary screens that may be provided by redemption interface 240 will be described below.

Loyalty system 200 may also include one or more additional communication interfaces 204 to obtain or provide information used by loyalty system 200 to administer loyalty programs. For example, communication interfaces 204 may be used to obtain account information for financial accounts (e.g., credit card accounts, checking accounts, savings accounts, mortgage accounts, etc.) associated with participants in loyalty programs. The financial account information may be obtained from a financial institution, loyalty provider, or other entity having information about the financial accounts. It should be appreciated that other types of communication interfaces 204 may also be included in loyalty system 200.

Logic 210 may be one or more software programs, one or more components of a software program (e.g., function or program object), firmware, or other type of machine-executable instructions that may be used to administer loyalty programs. The functionality performed by logic 210 may include reward calculation 212, reward redemption 214, loyalty program enrollment 216, coupon validation 218, and/or any other type of functionality used to administer loyalty programs. Logic 210 may interact with various data stores 220, 222, 224, 226 when performing loyalty program functionality.

Reward calculation logic 212 may determine whether a transaction qualifies for a reward, the reward type, and/or a reward amount to award for a transaction. Reward determinations may include applying one or more rules 220 to the transaction. In some embodiments, rules 220 may specify that reward eligibility, type and/or amount depend on attributes of a participant's associated account(s) (e.g., credit card, savings, checking, stored value, mortgage account, etc.), transaction history information associated with a participant, and/or other information about a participant. Information about participants' associated account(s) used to evaluate rule conditions may be obtained from a data store having information about associated accounts 222, loyalty account 226 information stored about a participant, and/or transaction information 224. Alternatively or additionally, attributes used to evaluate rule conditions may be obtained as needed by loyalty system 200 from a financial institution or other entity having the information.

An example of a type of rule that may be based on attributes of a participant's associated account is a rule that specifies that a transaction is not eligible for loyalty program rewards if a participant's credit card account associated with the loyalty program is overdrawn. As another example, a rule may specify that a transaction qualifies for a 0.5% rebate if an associated credit card account has a balance of $0-$1,000 and a 1% rebate if the associated credit card account has a balance of greater than $1,000. Additional examples of reward determinations that may be performed by reward calculation logic 212 are described below.

Logic 210 may update loyalty account information 226 to add the calculated reward amounts to a participant's loyalty account balance. In other embodiments, logic 210 may instead, or additionally, immediately provide loyalty rewards to the participant. By way of example, a transaction discount may immediately be provided to a participant and/or a coupon may be immediately issued to the participant. Other examples are provided below.

Reward redemption logic 214 may apply one or more rules 220 to determine reward type(s) and/or amount(s) available to a loyalty program participant redeeming loyalty rewards. For example, a loyalty program may offer a participant a choice of reward redemption options. The available choices may, in some instances, be determined by evaluating one or more rules 220. In some aspects, rules 220 may also specify conversion algorithms used by reward redemption logic 214 to convert to a selected redemption option. Merely by way of example, a rule may specify that loyalty program points are divided by 100 to determine an amount available for a charitable contribution. In other aspects, rule conditions may direct the reward redemption logic 214 to evaluate attributes of a participant's associated account(s), transaction history information, or other attributes about a participant. The participant information may be used to determine redemption options and/or to determine the conversion algorithm to apply to convert loyalty program points to other redemption options. In further aspects, reward redemption logic 214 may apply rules 220 to automatically redeem loyalty points as specified by the participant.

Program enrollment logic 216 may be used to automatically enroll participants in available loyalty programs based on enrollment rules 220. Merely by way of example, a loyalty program provider may create a rule 220 to automatically enroll a participant into a loyalty program for a particular merchant if the participant initiates a transaction with the merchant. Program enrollment logic 216 may also be used to remove participants from loyalty programs based on loyalty program rules, may use rules to determine whether a participant may self-enroll in a particular loyalty program, and/or may use rules to upgrade or downgrade a participant's loyalty status. In some aspects, enrollment criteria (automatic or self-enrolled), loyalty program removal, and or loyalty status changes may be based on attributes of a participant's associated account or accounts, transaction history information about a participant, and/or other information available about a participant.

Coupon validation logic 218 may be used to determine whether a loyalty program coupon presented for redemption is valid. In order to determine if a coupon is valid, coupon validation logic may consult loyalty account information 226 and/or other information stored by loyalty system related to the issuance of coupons. The results of the determination may then be transmitted back to a requester (e.g., point-of-sale device, kiosk, merchant server). If the coupon was valid, coupon validation logic 218 may also update the coupon status or other mechanism to indicate the coupon has been redeemed.

It should be appreciated that logic 210 may perform additional functionality related to the management of loyalty program accounts. By way of example, various reports may be provided by logic 210 to merchants, loyalty providers, and/or other entities participating in a loyalty program. As another example, logic 210 may process inquiries regarding loyalty program balances. Yet another example of functionality that may be performed by logic 210 is return processing to process transaction returns against loyalty program account. Further functionality that may be performed by a loyalty system 200 may also be found in application Ser. No. 10/079,927, previously incorporated by reference.

As previously described, loyalty system 200 may include one or more data stores 220, 222, 224, 226 to store information used by loyalty system 200 to administer loyalty program(s). Data store 220, 222, 224, 226 may be one or more relational databases, spreadsheet(s), text file(s), internal software list(s), or other type of data structure(s) suitable for storing data.

The rules data store 220 may be communicatively coupled with rules interface 230 and logic 210. Rules data store 220 may be used to store rules related to loyalty programs. The rules 220 may be default rules, rules created by a loyalty provider, and/or rules created by other entities associated with a loyalty program. A rule may include one or more conditions to evaluate and actions to apply if the condition(s) are satisfied. In some embodiments, a rule may be associated with event(s) that trigger the evaluation of a rule. Events that trigger rule evaluation may include receipt of transaction information (purchase and/or returns), redemption requests, predetermined time events (e.g., daily, end of cycle, month end, fixed date, fixed re-occurring date, etc.), receipt of account attribute or other attribute information, and/or any other type of event.

Rules 220 may store a variety of different types of rules. For instances, rules 220 may store rules used to determine loyalty program(s) available to participants, to specify automatic enrollment or other enrollment criteria, to specify automatic removal criteria to remove a participant from a loyalty program, and/or to specify exclusion criteria. As other examples, rules 220 may include rules used to calculate rewards, to determine reward types, to determine redemption options, to process returns. Other types of rules 220 may also be stored and used to administer loyalty program(s).

Associated accounts 222 may store attribute information for participants' associated account(s) used to evaluate rule conditions or otherwise administer loyalty program(s). In some aspects, the associated account attributes may be associated with a participant loyalty account number. Merely by way of example, the associated accounts may be credit card accounts, checking accounts, debit card accounts, savings accounts, mortgage accounts, other types of loan accounts, stored value accounts, and/or any other type of account associated with a participant and used by loyalty system 200 to administer loyalty program(s). Attributes of a particular associated account stored in associated accounts 222 may vary depending upon the information used to evaluate rules and/or the type of account. Exemplary attributes may include current balance, interest rate, deposit information, account status, payment information, average balance, date opened, number of items purchased since cycle start, and/or dollar amount of items purchased since cycle start. Other types of attributes may also be stored in associated accounts data store 222.

In some embodiments, associated accounts data store 222 may be periodically populated or updated by information received from financial institutions, credit card processing services, loyalty providers, and/or other entities having information about participants' associated accounts. Alternatively or additionally, information about a participant's associated account(s) may be dynamically obtained from financial institution(s), credit card processing services, or other entities. In still further aspects, associated accounts data store 222 may be data store(s) that are accessible by loyalty system 200 and maintained by another system or systems.

Transactions 224 may store information about transactions processed by loyalty system 200 or other transaction information. The transaction information may be used to evaluate conditions associated with rules used to administer loyalty programs. In some aspects, the transactions may be purchase transactions and may include for each transaction one or more of a participant's loyalty account number, a merchant identifier, a transaction type (e.g., purchase, return), item information (e.g., SKU, price), transaction total, date of purchase, payment type, payment account, and/or any other type of transaction information. In other aspects, the transaction information may be other types of transactions associated with a participant for which loyalty rewards may be awarded. Merely by way of example, the other types of transactions may be use of a particular service (e.g., ATM machine usage, usage of services offered by loyalty provider, etc.), access of information (e.g., web site access), or other activities associated with a participant (e.g., showing up for an event, such as a book review).

In some embodiments, transaction information may be used to update one or more attributes associated with a participants' loyalty account number. By way of example, the transaction information may be used to update a count for the number of items purchased by the participant, a dollar amount calculating the total amount spent, or other type of participant attribute based on transaction information. In some instances, the counters may be periodically reset (e.g., at the end of cycle). These attributes may also, in some embodiments, be used to evaluate rule conditions.

In still further embodiments, transactions 224 may also store information about enrollment transactions processed by loyalty system 200, redemption transactions, return transactions, inquiry transactions, and/or any other transaction processed by loyalty system 200. Loyalty system 200 may periodically report loyalty transaction information to loyalty program providers, merchants, or other entities associated with loyalty program(s) administered by loyalty system 200.

Loyalty accounts 226 may include information for participant loyalty accounts administered by loyalty system 200. By way of example, information for a loyalty account may include a loyalty account number, a loyalty account balance, customer information (e.g., name, address, phone number), account identifiers associated with the customer, and/or attributes based on transaction information. Other information about a participant's loyalty account may also or alternatively be stored in loyalty accounts 226 and/or transactions 224.

In some embodiments, a participant may be allowed to participate in more than one loyalty program. Thus, loyalty accounts 226 may include information about each loyalty program in which a participant is enrolled and a loyalty account balance for each program. A participant may be automatically enrolled in some loyalty programs by loyalty system 200. Enrollment information may also be obtained from loyalty provider(s). In some embodiments, loyalty system 200 may provide an interface to allow a participant to enroll in loyalty programs available to the participant.

It should be appreciated that loyalty system components 202-240 may perform additional, less, or alternative functionality than described. It should also be appreciated that loyalty system 200 may include additional, alternative, or fewer components than illustrated in FIG. 2. For example, an interface may be provided to allow administrators to view loyalty transaction or other reporting information. Other variations are also contemplated.

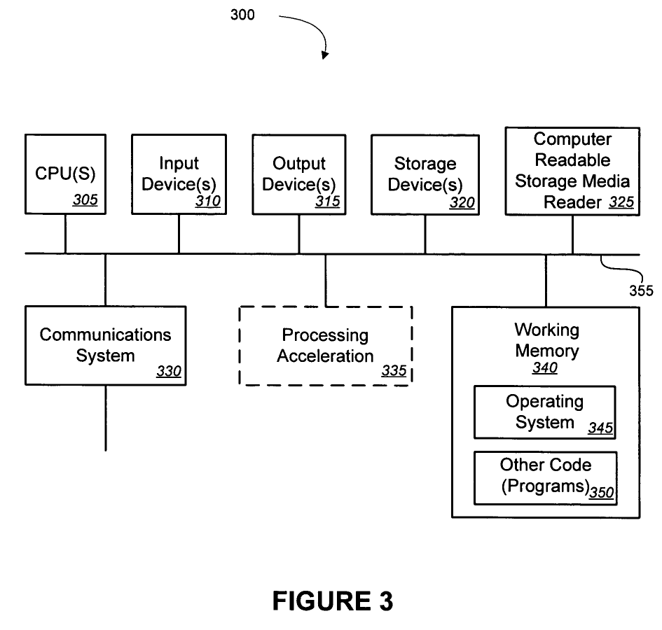

FIG. 3 illustrates one embodiment of a computer system 300 upon which a loyalty system or components of a loyalty system may be implemented. The computer system 300 is shown comprising hardware elements that may be electrically coupled via a bus 355. The hardware elements may include one or more central processing units (CPUs) 305; one or more input devices 310 (e.g., a scan device, a mouse, a keyboard, etc.); and one or more output devices 315 (e.g., a display device, a printer, etc.). The computer system 300 may also include one or more storage device 320. By way of example, storage device(s) 320 may be disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 325; a communications system 330 (e.g., a modem, a network card (wireless or wired), an infra-red communication device, etc.); and working memory 340, which may include RAM and ROM devices as described above. In some embodiments, the computer system 300 may also include a processing acceleration unit 335, which can include a DSP, a special-purpose processor and/or the like.

The computer-readable storage media reader 325 can further be connected to a computer-readable storage medium, together (and, optionally, in combination with storage device(s) 320) comprehensively representing remote, local, fixed, and/or removable storage devices plus storage media for temporarily and/or more permanently containing computer-readable information. The communications system 330 may permit data to be exchanged with a network and/or any other computer or other type of device, such as a POS device or kiosk.

The computer system 300 may also comprise software elements, shown as being currently located within a working memory 340, including an operating system 345 and/or other code 350, such as an application program. The application programs may implement a loyalty system, components of a loyalty system, and/or the methods of the invention. It should be appreciate that alternate embodiments of a computer system 300 may have numerous variations from that described above. For example, customized hardware might also be used and/or particular elements might be implemented in hardware, software (including portable software, such as applets), or both. Further, connection to other computing devices such as network input/output devices may be employed.

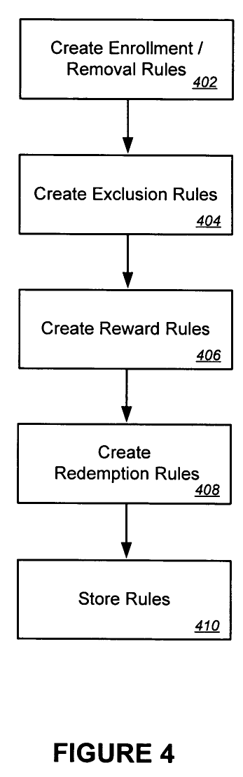

FIG. 4 illustrates exemplary creation of rules that may be used to administer loyalty programs. Rules may be created by a loyalty provider using a rules interface or other interface to loyalty system. Other entities may also create rules and other mechanisms may be used to create the rules. It should be appreciated that rules may be created or updated at any point in time. Thus, loyalty system may provide loyalty providers with a great deal of flexibility in setting up and defining the operation of loyalty programs.

In some embodiments, rules may be associated with one or more trigger events which trigger the evaluation of condition(s) associated with the rule. If the condition(s) are satisfied, one or more actions associated with the rule are taken. Merely by way of example, rules may be triggered by receipt of transaction information for the purchase of goods or services, receipt of transaction information for a return transaction, at predetermined times (e.g., end-of-cycle, monthly, quarterly, yearly, fixed date, etc.), by receipt of redemption requests, and/or by receipt of associated account attributes or other participant information. Other types of events may also trigger the evaluation of rules associated with loyalty programs.

Loyalty system may allow providers to create 404 enrollment rules to specify eligibility criteria for one or more loyalty programs offered by the loyalty provider. In some instances, loyalty providers may allow participants to participate in multiple loyalty programs. For example, a provider may allow a participant to enroll in a loyalty program which provides rewards based on purchases at merchant A and a second loyalty program which provides rewards based on purchases at merchant B. Enrollment rules may be triggered if a participant requests to enroll in a particular loyalty program. The loyalty system may evaluate attributes associated with the participant to determine to enroll the participant or deny the request.

In further embodiments, loyalty system may automatically enroll participants in loyalty programs. The enrollment rules created 402 by the loyalty provider may specify conditions that are evaluated by the loyalty system for one or more candidate participants to determine if the participant should be automatically enrolled in a loyalty program. Alternatively or additionally, enrollment rules may be created 402 that specify the loyalty system should issue an enrollment offer to qualified candidates, instead of automatically enrolling the participant. Rules created 402 to automatically enroll or extend offers to candidate participants may be triggered at predetermined times (e.g., end of cycle date, end of year, etc.) and/or or upon the occurrences of specified events (e.g., receipt of financial account information). Rules may also be created to automatically remove participants from loyalty programs, change the participant's loyalty status (upgrade and/or downgrade) and/or issue impending removal warnings to participants.

As can be appreciated, many different types of enrollment rules may be created that specify enrollment criteria for loyalty programs. In some aspects, the criteria may be based on attributes of one or more associated account(s), transaction history information associated with a candidate participant, or other types of attributes associated with the candidate participant. One example of a type of enrollment rule that may be created 402 by a loyalty provider is an enrollment rule that specifies if a candidate participant's year-end purchases for a specified credit card account are greater than $60,000, the candidate participant should be automatically enrolled in a bonus loyalty program which may provide extra reward incentives (e.g., extra 1% cash back). Another example is that if the candidate participant purchased over $10,000 of goods or services from merchants participating in loyalty program(s) offered by the provider, a reward level attribute associated with the participant should be increased by 0.5%. A third example is that if a participant's credit card transaction information includes a transaction for merchant A, an invitation should be extended to the participant to enroll in a loyalty program associated with merchant A. An example of a rule that may be created to automatically remove a participant from a loyalty program is that if a participant does not make any purchases from participating merchant(s) within a specified time period, the participant should be automatically removed from a loyalty program. Numerous other types of enrollment rules and/or removal rules may be created 402 by loyalty providers.

Loyalty providers or other authorized entities may create 404 exclusion rules that specify conditions to exclude participants from accruing rewards for otherwise qualified transactions. Alternatively, or additionally, exclusion rules may be created 404 to specify conditions that prevent a participant from redeeming loyalty rewards. The exclusion rules may be triggered by the receipt of transaction information for the purchase of goods or services, redemption requests, and/or may be invoked at any time during when loyalty rewards are calculated or redeemed. Conditions associated with exclusion rules may be based on attributes associated with the participant. The participant attributes may include associated account(s) attributes, transaction history attributes, or any other type of attribute associated with the participant.

By way of example, an exclusion rule may specify that if one or more financial accounts (e.g., credit card account, loan account) associated with the participant are delinquent, the participant cannot accrue loyalty points. An action may be taken to notify the participant that the transaction was ineligible for loyalty points because the account(s) were delinquent. As another example, an exclusion rule may be created 404 that prevents a participant from redeeming loyalty rewards if a specified financial account is delinquent and/or over an allowed limit. Other types of exclusion rules may also be created 404.

Reward rules may be created 406 to specify the types of transactions that qualify for loyalty rewards and/or how the loyalty rewards should be calculated. The reward rules may be triggered upon the receipt of transaction information for the purchase of goods or services. The transaction information may be received in real-time or may be received at a later time (e.g., in a batch job). Reward rules may also be triggered by the occurrence of other events or specified dates, such as end-of-cycle dates or the receipt of associated account or other information.

The conditions associated with reward rules may use any type of information available to loyalty system. By way of example, conditions associated with reward calculation rules may include parameters such as transaction history parameters (e.g., total purchases within a given time period, number of days since last purchase, number of purchases in a given time period, etc.), associated account(s) attribute parameters (e.g., credit card balance, credit card status, number of deposits made, mortgage balance, existence of other accounts, etc.), or other parameters for other types of attributes associated with participants (e.g., credit card score, etc.). In some embodiments, rewards may be divided between multiple loyalty accounts. Thus reward rules may be created which use attributes associated with the participant specifying how the rewards are to be divided between the programs.

Reward rules may specify that rewards are to be awarded to participants in any number of formats. In some instances, rewards may be awarded immediately. Merely by way of example, rewards may immediately be provided by issuing an immediate transaction discount, printing a coupon at a point-of-sale or kiosk, emailing a coupon to the participant, providing a free product to the participant, and/or loyalty points may be immediately added to a participant's account balance. In other aspects, rewards may be provided at a later date and may, in some cases, be conditioned on the occurrence of a second event. For instances, coupons or checks may be mailed at a later date, a credit may be provided on the participant's credit card statement, loyalty points may be added at a later date, and/or a discount may be applied at a point-of-sale for a subsequent transaction.

Numerous types of reward rules may be created 406. Merely by way of example, a reward rule may specify that if an attribute of a participant's credit card account indicates the credit card is a classic gold or platinum card, the total dollar amount of the purchase transaction is multiplied by 1% and the total is provided as an immediate discount for the purchase transaction. Another example of a reward rule is that if a first type of payment was used for the transaction (e.g., private label card A, credit card A, etc), then reward the participant with a specified number of points for every dollar. A companion rule may specify that if a second type of payment was used (e.g., private label card B), then reward the participant with a different number of points for every dollar. A third example of a reward rule is a rule that directs the loyalty system to give extra rewards if the transaction is the participant's first transaction associated with a particular loyalty program. A fourth example of a reward rule may be a rule that states if the participant has a mortgage account with a designated financial institution and the balance is greater than 100,000, provide an additional discount of 0.5% at the point-of-sale and/or issue a check to the participant for the discount amount. Yet another example is a rule that states if the participant purchased a certain number of items, the transaction total exceeds a particular amount, and/or a particular item was purchased, provide the participant with additional rewards, such as additional discount, loyalty points, free item, etc.

As previously stated, some reward rules may be created 406 that are triggered by dates, such as end of cycle dates. One example is a rule that states that at the end of the cycle, obtain the total sales for the cycle associated with a credit card account, add the total amount of cash advances, subtract any return amounts and multiply the total by 25%. The calculated amount may then be added to a participant's loyalty account balance. A second example is a rule that multiplies the total dollar amount of transactions associated with a participant's loyalty account for a predefined time period (monthly, quarterly, cycle, etc.) by a designated percentage and issues a check to the participant for the reward amount. Another example, is that at the end of a month, if the participant has obtained a loan, such as a mortgage or automobile loan, from a particular financial institution (e.g., a financial institution associated with the loyalty provider), add a number of points to the participant's loyalty account balance and/or issue a check to the participant (for a fixed amount or an amount calculated based on loan balance). Other rules may also provide participants with extra rewards for having accounts with designated financial institutions or other entities. A fourth example may be a rule that states at the end of the month if the participant has made X number of deposits in his associated savings or checking account, add a certain number of loyalty points to the participant's account. It should be appreciated that many other examples of reward rules may be created 406.

Loyalty system may also allow loyalty providers to create 408 redemption rules. Redemption rules may be used to determine the types of redemption options available to a participant, when and how rewards should be issued, conversion algorithms to convert loyalty points to monetary amounts, and/or any other type of rule used to administer redemptions. Redemption rules may be triggered by the receipt of redemption requests, at predetermined times, or by any other suitable event.

One example of a redemption rule is a rule that states the conditions for a participant to be able to redeem loyalty points for cash. Another redemption rule may state how loyalty points are converted to dollars. In some embodiments, the conversion of loyalty points to dollars may vary based on financial account attributes, loyalty transaction attributes, or other attributes associated with a participant. By way of example, a rule may state that if a participant's credit card balance is over 1,000 and the participant's second credit card balance is over 2,000, then divide the total number of loyalty points by 1,000 to determine the cash back amount, otherwise divide the total number of loyalty points by 500. As another example, a redemption rule may state that the redemption of a reward for a gift certificate should be issued as a stored value credit. Yet another example of a redemption rule is a rule that specifies conditions for matching a reward (e.g., a charitable contribution match by the loyalty provider or other entity) and actions to apply to match the reward (e.g., ACH transfer from a loyalty provider account to the charity account). Numerous other types of redemption rules may be created 408.

Rules created in blocks 402, 404, 406, and/or 408 may be stored 410 in one or more data stores. Upon the occurrence of a triggering event, the loyalty system may retrieve the rules associated with the triggering event, evaluate the condition(s) associated with the retrieved rules, and if the conditions are satisfied, apply the associated action(s). It should be appreciated that rules other than the rules described in FIG. 4 may also or alternatively be created and used to administer loyalty programs. By way of example, rules may be created to specify how return transactions should be processed to reverse loyalty rewards previously issued. Other types of rules are also contemplated.

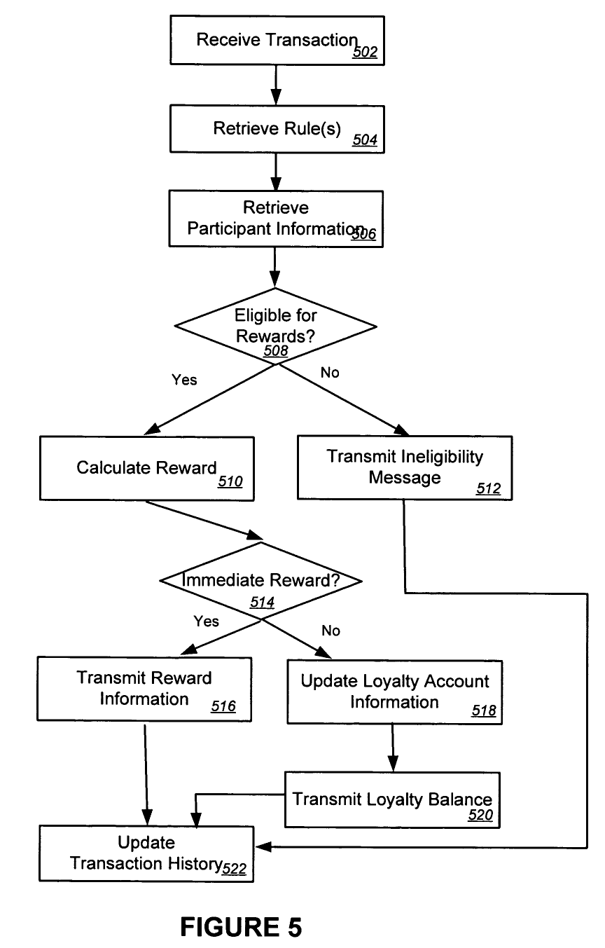

FIG. 5 illustrates an exemplary method that may be used to process a loyalty transaction in real-time. The loyalty system may receive 502 transaction information for a transaction for the purchase of goods or services or other transaction for which loyalty points may be rewarded (e.g., based on activities of participants, usage of services, etc.). The transaction information may be received 502 from a POS device, a kiosk, a merchant computer, or other device. The transaction information may include details about the transaction. By way of example, the transaction details may include a loyalty account number or other participant identifier, a merchant identifier, a transaction type, a total dollar amount, payment type, payment account, details about items or services purchased (e.g., SKU numbers or other item identifiers), and/or other information about the transaction.

At block 504, rules may be retrieved that are triggered by the receipt of real-time transactions. The rules may be used by loyalty system to determine whether the transaction qualifies for loyalty rewards, whether to exclude the transaction, how to calculate rewards, how the rewards should be issued, or any other type of rule triggered by the receipt of the transaction 502.

One or more of the retrieved rules 504 may include conditions that evaluate attributes about a participant, such as transaction history attributes, associated account attributes, or other types of attributes. Loyalty system obtains 506 the attributes used in the rule conditions. The attributes may be obtained 506 from one or more data stores. Alternatively, or additionally, the loyalty system may request the information from another system or systems having the information.

At block 506, the loyalty system may use the rules to determine 508 whether the transaction is eligible for rewards. For instances, rules may state that the transaction is only eligible for rewards if a certain payment type was used. As another example, the transaction may be determined 508 to be ineligible because a financial account associated with the participant is delinquent or overdrawn. Other transaction details, associated account(s) attributes, prior transaction attributes, or other attributes about a participant may also be used to determine the participant or transaction is not eligible for rewards.

If the transaction is not eligible for rewards, a message may be transmitted to the point-of-sale device, kiosk or merchant server that the transaction is not eligible. In some embodiments, this information may be relayed to the participant (e.g., on a receipt). Loyalty transaction history information and/or participant attributes associated with loyalty transactions may be updated at block 522 to include information about the received 502 transaction.

If the transaction is eligible for rewards, the loyalty system may then use rules to calculate 510 the reward or rewards to be awarded to the participant. Any of the details about the transaction or the obtained participant information may be used to calculate 510 the rewards. In some instances, rewards may be provided from multiple loyalty providers. For example, the participant may receive a first reward from a credit card issuer issuing the credit card used to pay for the transaction, a second reward from the merchant, and a third reward from a manufacturer of an item purchased in the transaction.

At block 514, a determination may be made whether any rewards are to be issued immediately. If reward(s) are to be issued immediately, the reward information is transmitted 516 to the merchant device. The merchant device or other device may then issue the rewards in the specified format (e.g., coupon, discount, free product, etc.). At block 522, transaction history information and/or attributes associated with loyalty transactions may be updated.

If any awards are not issued immediately, loyalty account information associated with the participant may be updated 518 with the reward information. By way of example, points may be added to a loyalty account balance. In some aspects, an updated loyalty balance may be transmitted 520 to the merchant device, which may then convey the information to the participant. Loyalty transaction history information and/or participant attributes associated with loyalty transactions are also updated 522.

It should be appreciated that variations may be made to the method described above. For example, additional messages for the participant may be transmitted to the merchant device. These messages may include promotion offers, loyalty program enrollment offers, loyalty account information, or any other type of message associated with loyalty program(s) administered by a loyalty system. It should also be appreciated that in other embodiments, transaction information may not be received in real-time. Thus, variations may be made to the illustrated method to issue rewards for transaction information received at a later time.

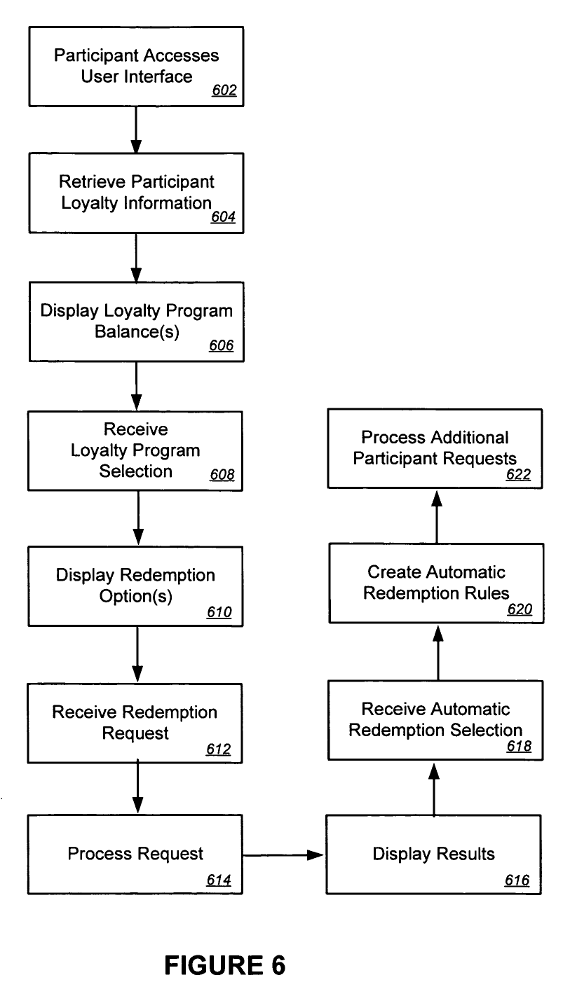

FIG. 6 is a flow diagram illustrating an exemplary interaction of a participant with a user interface provided by a loyalty system The user interface may be provided by a loyalty system to allow the participant to manage his or her loyalty account or accounts and/or to redeem loyalty rewards.

At block 602, the participant access the user interface. The user interface may require the user to provide appropriate authorization credentials to access the loyalty account information. Loyalty system may then retrieve 604 the participants loyalty information.

The user interface may display the loyalty program(s) in which the participant is enrolled. The reward balances (e.g., number of available reward points) for each loyalty program may also be displayed 606.

At block 608, the user interface may receive a selection of one of the loyalty programs from the user. The loyalty system may then create a second display which displays 608 the redemption options available for the selected loyalty program. By way of example, redemption options may include gift certificates, charity donations, travel rewards, merchandise rewards, money transfer options, transfers to college savings or other investment accounts, transfers to checking/saving accounts, transfer to loan accounts, purchase or reduction in price of services (e.g., mortgage refinance costs), and/or any other type of redemption option offered by a loyalty provider. In some aspects, the redemption options available may be determined based on one or more redemption rules or other loyalty program rules. Thus, in some aspects, redemption options may not be displayed if exclusion rules indicate the participant is excluded from using the redemption option (e.g., because of a delinquent financial account).

The user may select one of the available redemption options. The selected redemption option is received 612 by the loyalty system and the request is processed 614. The redemption request may trigger one or more exclusion rules as previously described. Thus, in some cases, the redemption request may be denied. For example, a redemption request may be denied if a participant's associated financial account is delinquent. Other rules may also be triggered by the redemption request, such as rules to determine how to convert to the selected redemption option and/or other.

The processing of allowed redemption requests may vary depending upon the redemption option chosen. In some aspects, the redemption request may be processed by initiating an ACH transaction from the loyalty system (or loyalty provider account) to an account specified by the participant (investment account, loan account, savings/checking account, charitable account, etc.). In other aspects, a gift certificate, check, or merchandise may be mailed to the participant or designated recipient (charity, etc.). In still further aspects, the loyalty system may access a money transfer system to initiate a money transfer to a recipient designated by the participant. Further details of exemplary money transfer transactions and systems are disclosed in application Ser. No. 09/975,171, entitled “Method and System for Performing Money Transfer Transactions, filed on Oct. 10, 2001, the details of which are hereby incorporated by reference.

The processing may also include deducting the number of points associated with the request from the participant's loyalty program balance. After the request is processed, the results may be displayed 616. Displayed results may include whether the redemption was successful or denied, the participant's updated loyalty account balance, promotional offers, invitations to enroll in other loyalty programs, or other loyalty program messages.

Some embodiments of loyalty system may allow the participant to set up automatic redemptions. Thus, the loyalty system may receive 618 a selection from the participant to set up an automatic redemption for a loyalty program. The user may be able to create 620 the automatic redemption rules used to automatically redeem loyalty points associated with the program. As one example, a participant may select to automatically transfer loyalty points to a selected charity or charities. As another example, a participant may select to automatically redeem loyalty points with a transfer to the participant's savings account. Other automatic redemption rules may also be specified. The automatic redemption rules may be triggered by the award of loyalty points or other rewards and/or accrual of a predetermined number of loyalty points or other events triggering the automatic redemption of loyalty awards.

The loyalty system may also process one or more additional participant requests 622 related to the participant's loyalty program(s). It should be appreciated that the illustration in FIG. 6 is intended to be exemplary in nature only. In alternative embodiments, other interactions may be performed by a user.

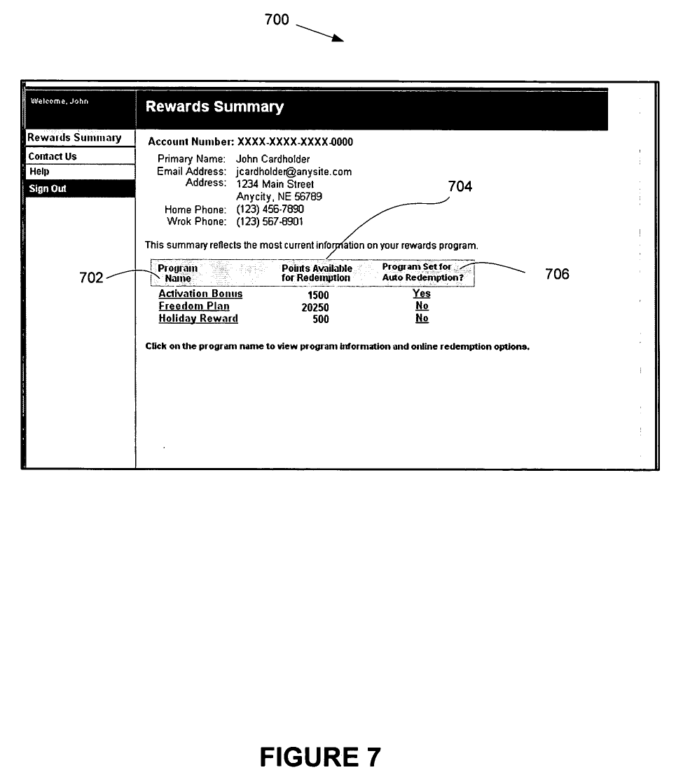

FIGS. 7-11 illustrate exemplary displays that may be provided by a loyalty system to display information to a participant and/or to allow the participant to redeem rewards. In one embodiment, the illustrative displays may be provided in a web-based application. Alternatively, another type of graphical user interface may be used. It should be appreciated that figures are intended to be illustrative in nature only and that variations may be made to the layout or information exemplified by these figures. It should also be appreciated that additional, fewer, or alternative displays may be provided by a loyalty system.

The display illustrated in FIG. 7 may be used to provide overall loyalty program information to a participant. A first column 702 may be used to display the loyalty programs in which the participant is enrolled and a second column 704 may be used to display the loyalty points available for each loyalty program displayed in column 702. Optionally, another column 706 may be displayed to provide information about whether the loyalty program in column 702 is set up for automatic redemption. Other information about the loyalty programs in which the participant is enrolled may alternatively or additionally be provided in display 700.

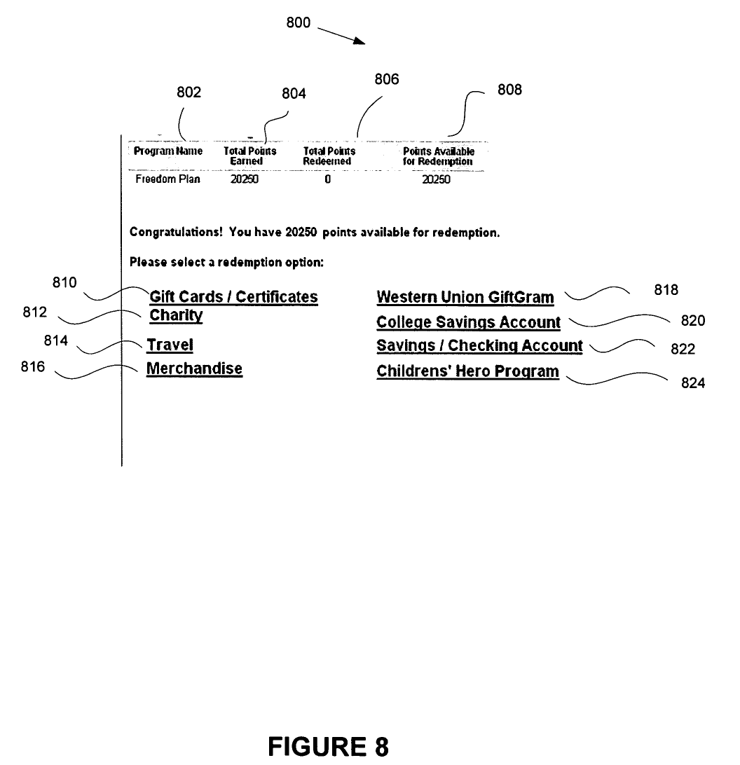

FIG. 8 illustrates an exemplary user interface display 800 that may be used to redeem loyalty points for a particular program. The display may include an area 802 to display the loyalty program name, an area 804 to display the total number of points earned, an area 806 to display the total number of points redeemed, and/or an area 808 to display the number of points available for redemption.

The display 800 may also list the redemption options available for the selected loyalty program. By way of example, available redemption options may include gift certificates 810, charitable contributions 812, travel rewards 814, merchandise rewards 816, money transfers 818, college savings contribution 820, and/or savings or checking account transfer 822. A featured charity may also be displayed 824. Other types of redemption options may alternatively or additionally be available to the participant and displayed in display 800. The participant may be able to interact with display 800 to select one of the available redemption options. In other embodiments, display 800 may include additional or alternative information than illustrated in FIG. 8.

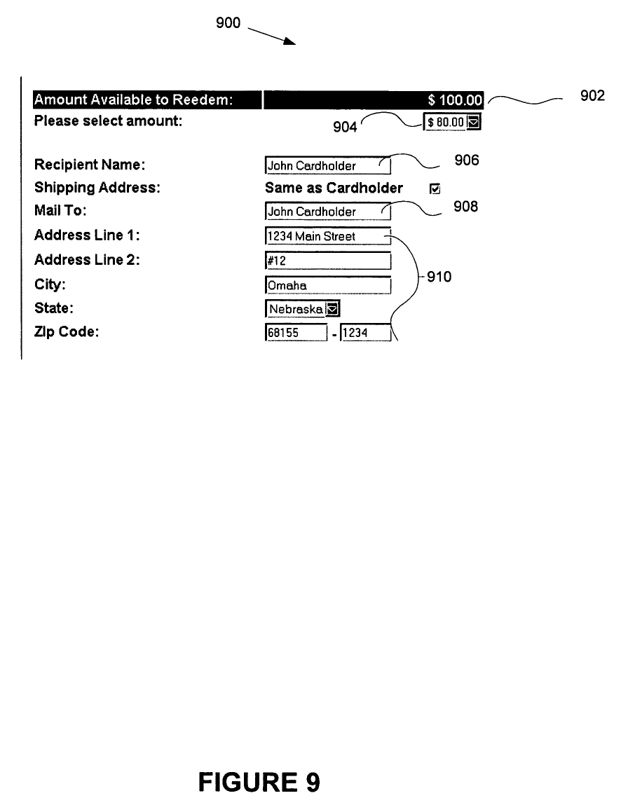

FIG. 9 illustrates an exemplary display that may be provided by a loyalty system to allow a participant to redeem loyalty points for a money transfer. The display may include an area 902 to display information about the amount available for money transfers. In some aspects, the available amount for a money transfer may be determined by the loyalty system by applying one or more rules specifying how the loyalty points are converted to dollars available for a money transfer.

Another area 904 may be provided for the participant to select the money transfer amount. Display 900 may also include areas for the participant to provide the recipient name 906 and mailing address 910. It should be appreciated that the recipient may be the participant or other individual or entity designated by the participant. In some embodiments, the money transfer information may be mailed to the recipient at the designated address or sent to the recipient as a “money gram”. Alternatively, the money transfer information may be provided electronic ally or the participant may notify the recipient of the money transfer identifier. It should be appreciated that a similar display may be used to allow a participant to redeem rewards by mailing a check to a designated recipient.

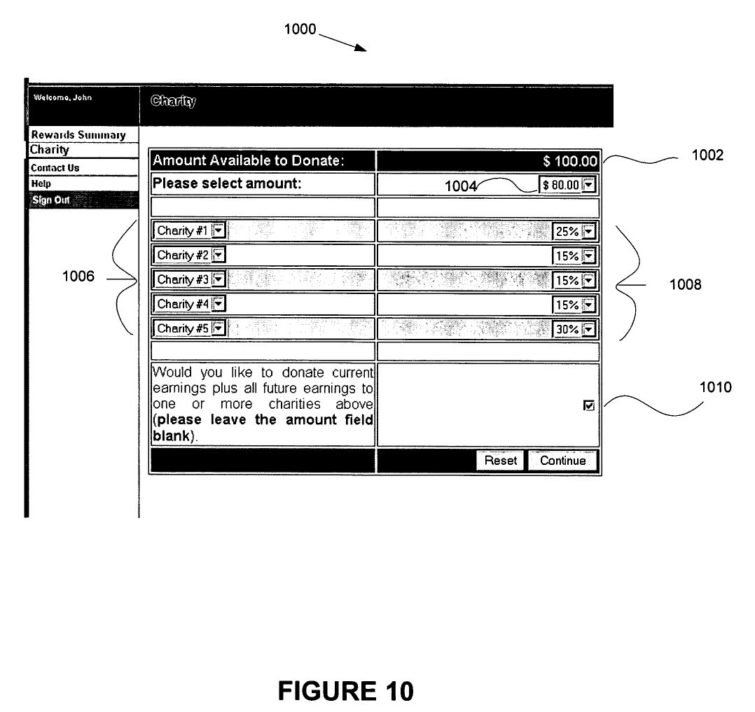

FIG. 10 illustrates an exemplary display that may be provided by a loyalty system to redeem loyalty points for a charitable donation. The display 1000 may include an area 1002 to display the amount available to donate to charity. In some aspects, this amount may be calculated by applying redemption rules specifying how to convert loyalty points to dollars available for charitable donations. A second area 1004 may be included to allow the participant to select the amount to be donated.

The participant may be able to donate the selected amount to one or more charities. Thus, display 1000 may include an area 1006 for the participant to designate the recipient charities and another area 1008 for the participant to designate the percentage of the total contribution to send to the associated charity. In some embodiments, the participant selects the charities from a list of eligible charities. Alternatively, the participant may be able to specify the charity to receive the reward.

Display 1000 may also provide an area 1010 for a user to set up automatic redemption of rewards to specified charities. By way of example, a selection mechanism (e.g., checkbox) may be provided to donate all future rewards to the charities as specified in areas 1006, 1008. Other mechanisms or displays may alternatively be used to allow a participant to set up other automatic redemptions for a loyalty program.

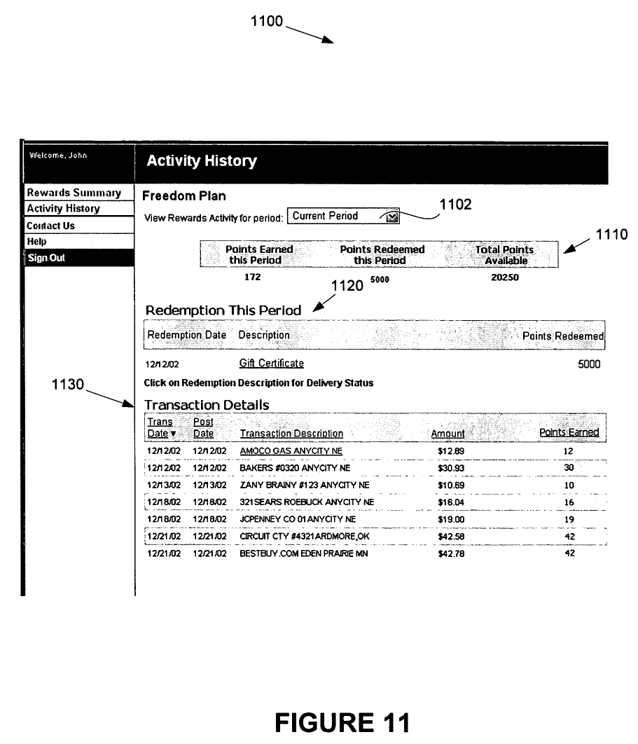

FIG. 11 illustrates an exemplary display 1100 that may be provided to display detailed loyalty program information. An area 1102 may be provided to allow the participant to select the time period to view loyalty transaction information. By way of example, the user may select to view loyalty program activity for the current period, previous month, previous quarter, previous year, or other time period. Another area 1100 may be used to display information about loyalty points accrued and/or redeemed for the selected period. Optionally, a total number of points available may also be displayed in this area 1110.

A third area 1120 may be provided to list redemption transactions that occurred during the selected period. The redemption transaction information displayed may include a redemption date, a description of the redemption type, and/or the number of points redeemed. In some embodiments, the user may be able to select a particular transaction to get more detailed information about the redemption transaction.

Display 1100 may further include area 1130 to display transactions for the purchase of goods or services for which the participant received loyalty points. Area 1130 may also, in some embodiments, display transactions for the refund of goods or services which resulted in the participant losing loyalty points. The transaction details displayed in area 1130 may include the transaction date, the date the loyalty points posted to the account, a brief description of the transaction, the transaction amount, and/or the number of loyalty points earned for the transaction. Some embodiments of display 1100 may allow the participant to select a transaction to display more detailed information about the transaction, information about how the loyalty points for the transaction were calculated, and/or information about other rewards that were received for the transaction. In other embodiments, display 1100 may include additional, alternative, or less information than described.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method comprising:
obtaining, with a loyalty system, an enrollment rule for a loyalty program, the enrollment rule including one or more enrollment conditions for the loyalty program;
obtaining, with the loyalty system, at least one attribute associated with a candidate participant;
evaluating the enrollment conditions using the at least one attribute; and
if the enrollment conditions are satisfied, automatically enrolling the candidate participant in the loyalty program.

2. The method of claim 1, wherein the enrollment conditions comprise a associated account condition.

3. The method of claim 2, wherein the attribute comprises one of an account balance, an available balance, and an account status.

4. The method of claim 2, wherein the attribute comprises a total purchase amount for a designated time period.

5. The method of claim 2, wherein the enrollment condition comprises existence of the associated account.

6. The method of claim 2, wherein the associated account comprises one of a credit card account, a checking account, a savings account, and a loan account.

7. The method of claim 1, wherein the enrollment condition comprise a transaction history condition.

8. The method of claim 7, wherein the attribute comprises a total purchase amount for a designated time period.

9. The method of claim 7, wherein the attribute comprises a purchase of a designated item.

10. The method of claim 7, wherein the attribute comprises a purchase from a designated merchant.

11. The method of claim 1, wherein the candidate participant is a participant in a second loyalty program administered by the loyalty system.

12. The method of claim 1, further comprising:
obtaining, with the loyalty system, a second enrollment rule for a second loyalty program, the second enrollment rule including one or more enrollment conditions for the second loyalty program; and
determining if the candidate participant satisfies the enrollment conditions for the second loyalty program.

13. The method of claim 12, further comprising if the candidate participant satisfies the enrollment conditions for the second loyalty programs, transmitting an offer to the candidate participant to enroll in the second loyalty program.

14. The method of claim 13, further comprising:
before obtaining the second enrollment rule, receiving transaction purchase information from a merchant device, the transaction purchase information associated with the candidate participant; and
wherein transmitting the offer comprises transmitting an offer message to the merchant device.

15. The method of claim 1, further comprising:
obtaining, with the loyalty system, a removal rule for the loyalty program, the removal rule including one or more removal conditions for the loyalty program;
determining, with the loyalty system, if a participant in the loyalty program satisfies the removal conditions; and
if the participant satisfies the removal conditions, automatically removing the participant from the loyalty program.

16. The method of claim 15, wherein the removal condition comprises failure to meet a purchase threshold for a predetermined time period.

17. A loyalty system comprising:
a rules data store including an enrollment rule for a loyalty program, the enrollment rule having one or more enrollment conditions for the loyalty program; and
logic, communicatively coupled with the rules data store, the logic configured to obtain the enrollment rule from the rules data store, to obtain at least one attribute for a candidate participant, to evaluate the enrollment conditions using the at least one attribute, and if the enrollment conditions are satisfied, to automatically enroll the candidate participant in the loyalty program.

18. The loyalty system of claim 17, further comprising:
an attribute data store to store participant attributes for a plurality of participants in one or more loyalty programs administered by the loyalty system; and
wherein the logic is configured to obtain the at least one attribute from the attribute data store.

19. The loyalty system of claim 18, wherein the participant attributes include at least one associated account attribute for an associated account.

20. The loyalty system of claim 17:
wherein the rules data store further includes a removal rule, the removal rule having one or more removal conditions for the loyalty program; and
wherein the logic is further configured to obtain the removal rule, to determine if a participant in the loyalty program satisfies the removal conditions, and if the participant satisfies the removal conditions, automatically removing the participant from the loyalty program.

21. The loyalty system of claim 17, further comprising an interface to receive the enrollment rule from a loyalty provider.

22. At least one machine-readable medium, having stored thereon sequences of instructions, which, when executed by the machine, cause the machine to perform the actions of:
obtaining an enrollment rule for a loyalty program, the enrollment rule including one or more enrollment conditions for the loyalty program;
obtaining at least one attribute for a candidate participant;
evaluating the enrollment conditions using the at least one attribute; and
if the enrollment conditions are satisfied, automatically enrolling the candidate participant in the loyalty program.
